(19) United States
(12) Patent Application Publication
(10) Pub. No.: US 2020/0040856 A1
(43) Pub. Date: Feb. 6, 2020

(54) INJECTOR HAVING STRUCTURE CAPABLE OF REDUCING REQUIRED INSERTION FORCE AND ASSEMBLY METHOD THEREOF

(71) Applicants: HYUNDAI MOTOR COMPANY, Seoul (KR); KIA MOTORS CORPORATION, Seoul (KR)

(72) Inventor: Choo-Saeng CHOI, Seongnam-si (KR)

(21) Appl. No.: 16/213,824

(22) Filed: Dec. 7, 2018

(30) Foreign Application Priority Data
Aug. 3, 2018 (KR) 10-2018-0090850

(51) Int. Cl. F02M 47/02

(52) U.S. Cl. CPC F02M 47/027; F02M 55/004

(57) ABSTRACT

An injector system includes a structure capable of reducing a maximum required insertion force which is generated when a plurality of injectors each provided with an O-ring are simultaneously assembled into respective injector insertion holes in a dual-point injection (DPI) engine system. The injector system of an engine includes a plurality of injectors mounted to a single intake port having injector insertion holes and inserted into respective injector insertion holes. The plurality of injectors comprise a first injector and a second injector. An O-ring and a back-up ring are mounted to each of the first and second injectors. An axial length of the back-up ring mounted to the first injector is different from an axial length of the back-up ring mounted to the second injector.

### CROSS-REFERENCE(S) TO RELATED APPLICATIONS

This application claims priority to Korean Patent Application No(s). 10-2018-0090850, filed on Aug. 3, 2018, which is incorporated herein by reference in its entirety.

### BACKGROUND

### Field

The present disclosure relates to an injector system of an engine.

### Description of Related Art

Generally, in multi-point injection (MPI) engine systems, an injector is installed for each cylinder to individually inject fuel from an intake port into the cylinder during a fuel injection process. In an example of the MPI engine system, each of injectors is mounted to each intake port (cylinder) and total four injectors are provided for cylinders each provided with one injector.

In a DPI engine system, for example, two injectors are mounted to each intake port (cylinder) and total eight injectors are provided for cylinders each provided with two injectors, and which is effective for improving fuel efficiency and reducing exhaust gas emission. Japanese Patent Unexamined Publication No. 2003-0314413 discloses the related technology.

### SUMMARY

An embodiment of the present invention is directed to an injector and an assembly method of the injector, which has a structure capable of reducing a maximum required insertion force which is generated when a plurality of injectors each provided with an O-ring are simultaneously inserted and assembled into respective injector insertion holes in a dual-point injection (DPI) engine system.

In accordance with an embodiment of the present invention, an injector system includes a plurality of injectors mounted to a single intake port and configured to be simultaneously inserted and assembled into respective injector insertion holes. The plurality of injectors may include a first injector and a second injector. An O-ring for fixing may be mounted to each of the first and second injectors. A back-up ring may be mounted to the first injector.

When the first injector and the second injector are simultaneously inserted into the respective injector insertion holes, a point in time at which the O-ring mounted to the first injector starts to be compressed may be different from a point in time at which the O-ring mounted to the second injector starts to be compressed.

The back-up ring may be disposed at a position closer to a rear end of the first injector than is the O-ring.

In accordance with an embodiment of the present invention, an assembly method of an injector includes a first injector and a second injector which are mounted to a single intake port and configured to be simultaneously inserted and assembled into respective injector insertion holes, wherein an O-ring for fixing is mounted to each of the first and second injectors, and a back-up ring is mounted to the first injector. The assembly method may include: an operation of simultaneously inserting the first injector and the second injector into the respective injector insertion holes; a first assembly operation in which the O-ring mounted to the first injector starts to be compressed; a second assembly operation in which the compression of the O-ring mounted to the first injector is completed and the O-ring mounted to the second injector starts to be compressed; and a third assembly operation in which the compression of the O-ring mounted to the second injector is completed.

The O-ring mounted to the second injector may not be compressed in the first assembly operation.

In the third assembly operation, the O-ring mounted to the first injector may be additionally injected into the corresponding injector insertion hole while a compressive force applied to the O-ring in the second assembly operation is maintained.

An insertion force applied to the first injector in the first assembly operation may be identical with an insertion force applied to the second injector in the second assembly operation.

A length by which the first injector is inserted into the corresponding injector insertion hole in the first assembly operation may be identical with a length by which the second injector is inserted into the corresponding injector insertion hole in the second assembly operation.

An insertion force applied to the first injector in the second assembly operation may be identical with an insertion force applied to the second injector in the third assembly operation.

A length by which the first injector is inserted into the corresponding injector insertion hole in the second assembly operation may be identical with a length by which the second injector is inserted into the corresponding injector insertion hole in the third assembly operation.

The back-up ring may be disposed at a position closer to a rear end of the first injector than is the O-ring.

In accordance with an embodiment of the present invention, an injector system includes a plurality of injectors mounted to a single intake port and configured to be simultaneously inserted and assembled into respective injector insertion holes. The plurality of injectors may include a first injector and a second injector. An O-ring for fixing and a back-up ring may be mounted to each of the first and second injectors. An axial length of the back-up ring mounted to the first injector may be different from an axial length of the back-up ring mounted to the second injector.

When the first injector and the second injector are simultaneously inserted into the respective injector insertion holes, a point in time at which the O-ring mounted to the first injector starts to be compressed may be different from a point in time at which the O-ring mounted to the second injector starts to be compressed.

The back-up ring may be disposed at a position closer to a rear end of the corresponding injector than is the O-ring.

In accordance with an embodiment of the present invention, an assembly method of an injector includes a first injector and a second injector which are mounted to a single intake port and configured to be simultaneously inserted and assembled into respective injector insertion holes, wherein an O-ring for fixing and a back-up ring are mounted to each of the first and second injectors, and an axial length of the back-up ring mounted to the first injector is greater than an axial length of the back-up ring mounted to the second injector. The assembly method may include: an operation of simultaneously inserting the first injector and the second injector into the respective injector insertion holes; a first assembly operation in which the O-ring mounted to the first injector starts to be compressed; a second assembly operation in which the compression of the O-ring mounted to the first injector is completed and the O-ring mounted to the second injector starts to be compressed; and a third assembly operation in which the compression of the O-ring mounted to the second injector is completed.

The O-ring mounted to the second injector may not be compressed in the first assembly operation.

In the third assembly operation, the O-ring mounted to the first injector may be additionally injected into the corresponding injector insertion hole while a compressive force applied to the O-ring in the second assembly operation is maintained.

An insertion force applied to the first injector in the first assembly operation may be identical with an insertion force applied to the second injector in the second assembly operation.

A length by which the first injector is inserted into the corresponding injector insertion hole in the first assembly operation may be identical with a length by which the second injector is inserted into the corresponding injector insertion hole in the second assembly operation.

An insertion force applied to the first injector in the second assembly operation may be identical with an insertion force applied to the second injector in the third assembly operation.

A length by which the first injector is inserted into the corresponding injector insertion hole in the second assembly operation may be identical with a length by which the second injector is inserted into the corresponding injector insertion hole in the third assembly operation.

The back-up ring may be disposed at a position closer to a rear end of the first injector than is the O-ring.

According to the present invention, the maximum insertion force required when injectors each provided with an O-ring are inserted into respective injector insertion holes in a DPI engine system may be reduced.

### BRIEF DESCRIPTION OF THE DRAWINGS

FIG. 1 is a diagram illustrating an MPI engine system.

FIG. 2 is a diagram illustrating a DPI engine system.

FIG. 3 is a diagram showing a point at which an O-ring mounted on an injector starts to be compressed when the MPI engine system shown in FIG. 1 or the DPI engine system shown in FIG. 2 is assembled;

FIG. 4 is a graph showing a required insertion force as a function of injector assembly sections in the MPI engine system shown in FIG. 1 and the DPI engine system show in FIG. 2.

FIG. 5 is a diagram illustrating an injector system of a DPI engine system in accordance with an embodiment of the present invention.

FIG. 6 is a conceptual diagram illustrating a first assembly step of FIG. 5.

FIG. 7 is a conceptual diagram illustrating a second assembly step of FIG. 5.

FIG. 8 is a conceptual diagram illustrating a third assembly step of FIG. 5.

FIG. 9 is a diagram illustrating an injector system of the DPI engine system in accordance with an embodiment of the present invention.

### DESCRIPTION OF EMBODIMENTS

Embodiments of the present invention will be described below in more detail with reference to the accompanying drawings so as to be easily realized by those skilled in the art. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Therefore, the size of each element, the thickness of lines illustrating the element, etc. may be exaggeratedly expressed in the drawings for the sake of understanding the present invention. Reference should now be made to the drawings, in which the same reference numerals are used throughout the different drawings to designate the same or similar components. In the description, details of well-known features and techniques may be omitted to avoid unnecessarily obscuring the gist of the present invention.

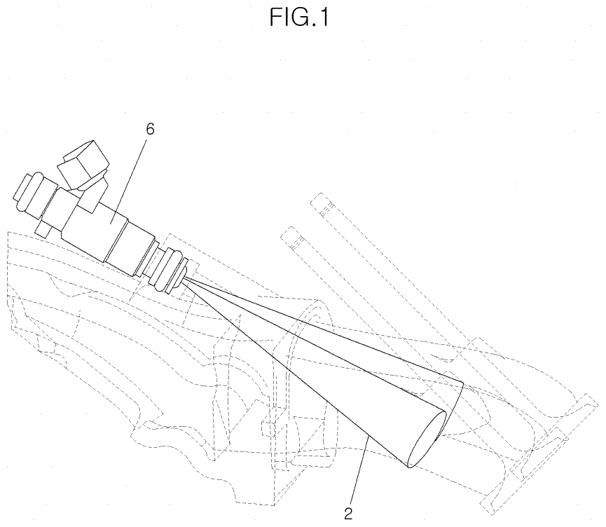

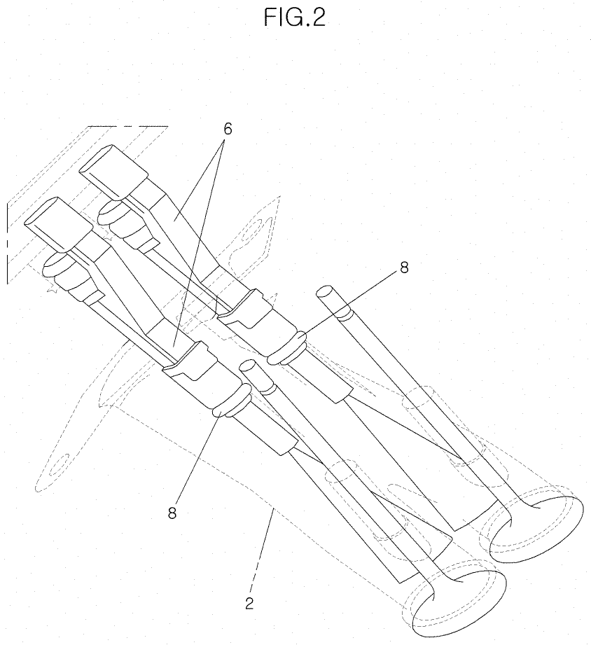

FIG. 1 illustrates a MPI system and FIG. 2 illustrates a DPI system. Referring to FIG. 2, two injectors 6 are mounted to each intake port (cylinder) 2 and total eight injectors 6 are provided for four cylinders, each of which is provided with two injectors. The DPI system shown in FIG. 2 is effective for improving fuel efficiency and reducing exhaust gas emission.

When inserting each injector 6 into the intake port 2 and fixing each injectors to the intake port 2, an O-ring 8 is used and mounted to the injector 6. In the MPI engine system show in FIG. 1 or DPI engine system show in FIG. 2, during an assembly process of the injectors 6, all of the injectors 6 are simultaneously inserted into respective injector insertion holes 4 and fixed thereto by compressive deformation of the O-rings 8.

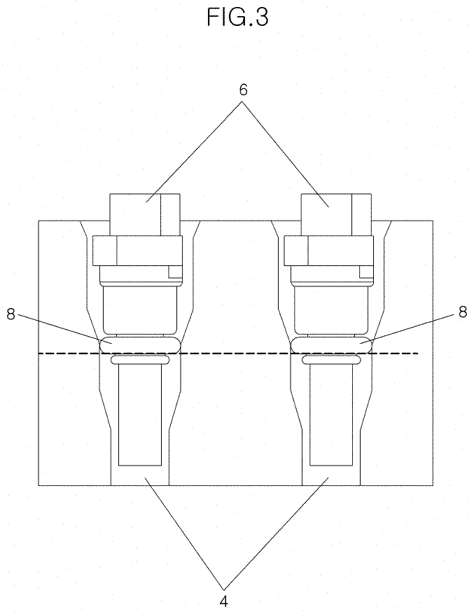

Therefore, as shown in FIG. 3, when the injectors 6 are inserted into the respective injector insertion holes 4 simultaneously, the O-rings 8 mounted to the respective injectors 6 are compressed at the same point in time. Hence, when portions of the injectors 6 on which the O-rings 8 are disposed are inserted into the injector insertion holes 4, instantaneous required insertion force is increased.

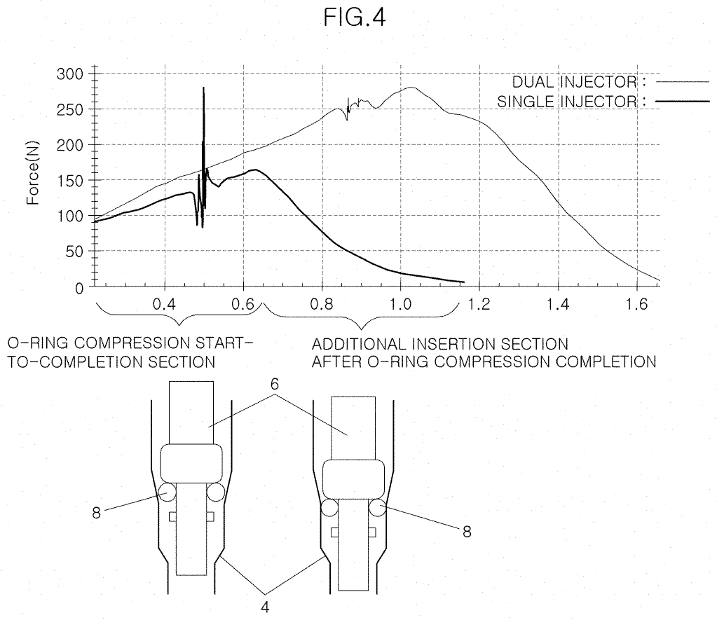

As shown in FIG. 4, in the case of the MPI engine system, when the four injectors are simultaneously assembled into the respective injector insertion holes, insertion force attributable to the four O-rings mounted to the four injectors is required. However, in the case of the DPI engine system, when the eight injectors 6 are simultaneously assembled into the respective injector insertion holes 4, insertion force attributable to the eight O-rings 8 mounted to the eight injectors 6 is required. Thus, compared to the injector assembly operation of the MPI engine system, required insertion force is increased, thereby making the assembly operation difficult.

According to embodiments of the present invention, an injector system has a structure capable of reducing required insertion force, and an assembly method thereof. Particularly, an injector system has a structure capable of reducing a maximum required insertion force which is generated when a plurality of injectors each provided with an O-ring are simultaneously assembled into respective injector insertion holes in a dual-point injection (DPI) engine system.

For example, in the DPI engine system, two injectors are mounted to each intake port, and total eight injectors are provided when the engine has four cylinders. An O-ring is mounted to each injector and used to fix the injector to the intake port when the injector is inserted into the intake port. When the injectors are assembled with the intake ports, the eight injectors are simultaneously inserted into the intake ports, and the O-rings mounted to the eight injectors are also simultaneously compressed.

Therefore, when the injectors applied to the DPI engine system are assembled with the intake ports, insertion force required to insert the injectors into the intake ports is greater than that of a multi-point injection (MPI) engine provided with total four injectors. Thus, it would not be possible to use existing assembly equipment or apply existing assembly methods when assembling the injectors with the intake ports of the DPI engine system.

In embodiments of the present invention, a plurality of injectors 10 and 12 which are inserted into each intake port 2 have different configurations so as to reduce the maximum insertion force required when the injectors 10 and 12 each provided with an O-ring 8 are assembled into respective injector insertion holes 4 in a DPI engine system.

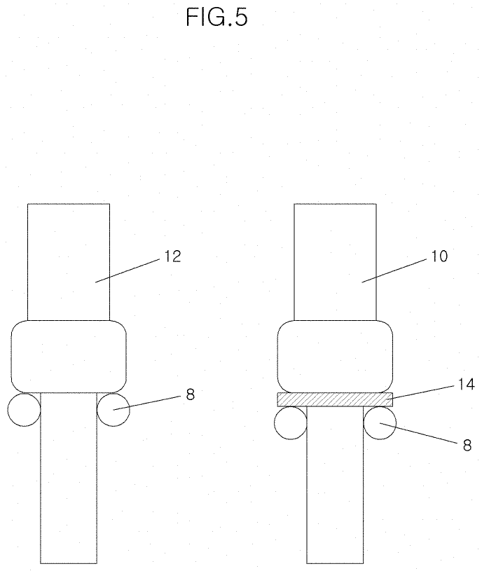

FIG. 5 is a diagram illustrating an injector system of the DPI engine system in accordance with embodiments of the present invention.

A plurality of injectors including a first injector 10 and a second injector 12 are inserted into and assembled with each intake port 2.

An O-ring 8 is mounted to each of the first and second injectors 10 and 12 and used to fix the injector 10, 12 to the intake port 2 when the injector 10, 12 is inserted into the intake port 2. A back-up ring 14 is mounted to any one of the first and second injectors 10 and 12. In the embodiment illustrated in FIG. 5, the back-up ring 14 is mounted to the first injector 10.

The back-up ring 14 is mounted behind the O-ring 8 with respect to a direction in which the first injector 10 is inserted into the corresponding injector insertion hole 4 of the intake port 2. In embodiments, each injector 10 or 12 includes a first portion and a second portion having a diameter greater than that of the first portion. The O-ring 8 has an inner diameter allowing the O-ring 8 to receive the first portion of the injector. The back-up ring 14 also has an inner diameter allowing the O-ring 8 to receive the first portion of the injector. The back-up ring is placed between the O-ring 8 and the second portion of the injector.

The first injector 10 and the second injector 12 have substantially the same size and substantially the same shape. The injector insertion holes 4 through which the first and second injectors 10 and 12 are inserted into the intake port 2 also have substantially the same size and substantially the same shape.

If the first injector 10 is not provided with the back-up ring 14, when the first injector 10 and the second injector 12 are simultaneously inserted into the corresponding injector insertion holes 4, the O-ring 8 mounted to the first injector 10 and the O-ring 8 mounted to the second injector 12 may start to be compressed at the same time because the O-rings 8 are disposed at the same axial positions of the first and second injectors 10 and 12.

However, in embodiments of the present invention, the back-up ring 14 is mounted to the first injector 10. Thus, when the first injector 10 and the second injector 12 are simultaneously inserted into the corresponding injector insertion holes 4, the O-rings 8 respectively mounted to the first and second injectors 10 and 12 start to be compressed at different points in time.

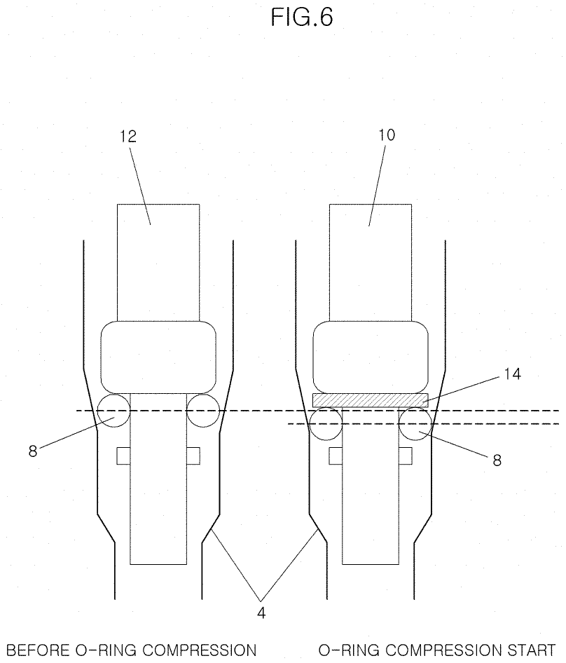

Hereinafter, a method of assembling the first injector 10 and the second injector 12 with the intake port 2 by inserting the first and second injectors 10 and 12 into the respective injector insertion holes 4 will be described in detail with reference to FIGS. 6 to 8.

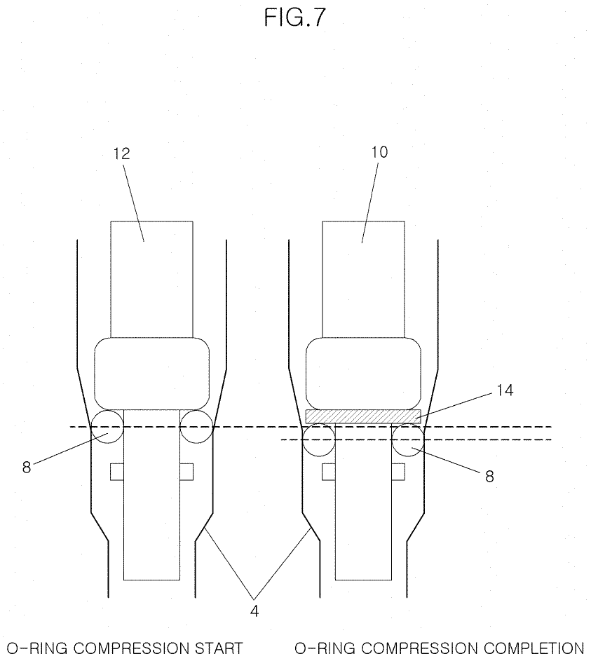

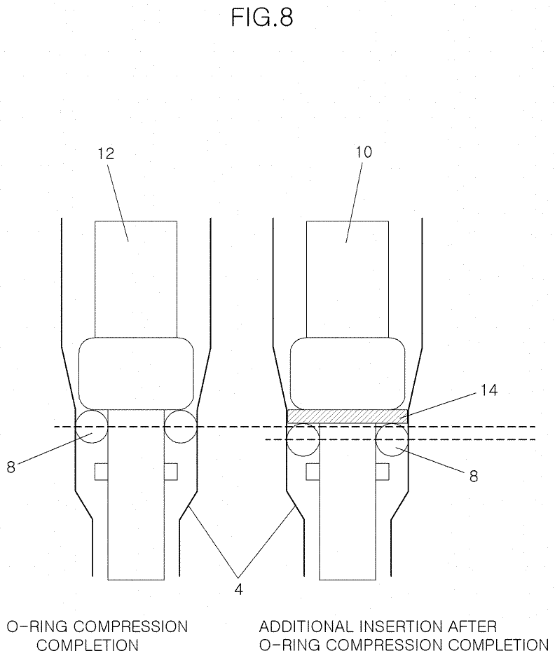

FIG. 6 is a conceptual diagram illustrating a first assembly step of FIG. 5, FIG. 7 is a conceptual diagram illustrating a second assembly step of FIG. 5, FIG. 8 is a conceptual diagram illustrating a third assembly step of FIG. 5.

The injector assembly method includes: the step of simultaneously inserting the first injector 10 and the second injector 12 into the respective injector insertion holes 4; a first assembly step at which the O-ring 8 mounted to the first injector 10 starts to be compressed; a second assembly step at which the compression of the O-ring 8 mounted to the first injector 10 is completed and the O-ring 8 mounted to the second injector 12 starts to be compressed; and a third assembly step at which the compression of the O-ring 8 mounted to the second injector 12 is completed.

The first injector 10 and the second injector 12 are respectively inserted into the plurality of injector insertion holes 4 formed in the single intake port 2. Although the insertion operations of the first and second injectors 10 and 12 are simultaneously performed, the positions of the O-rings 8 respectively mounted to the first and second injectors 10 and 12 differ from each other with respect to the axial direction of the first and second injectors 10 and 12 because of the back-up ring 14 mounted to the first injector 10.

Therefore, as shown in FIG. 6, when the O-ring 8 mounted to the first injector 10 starts to be compressed, the O-ring 8 mounted to the second injector 12 does not start to be compressed.

As the operations of inserting the first and second injectors 10 and 12 into the respective injector insertion holes 4 continue, the compression of the O-ring 8 mounted to the first injector 10 is completed according to the shape of the corresponding injector insertion hole 4, and then the O-ring 8 mounted to the second injector 12 starts to be compressed.

As the insertion operations of the first and second injectors 10 and 12 continue after the O-ring 8 mounted to the second injector 12 has started to be completed, the compression of the O-ring 8 mounted to the second injector 12 is completed according to the shape of the corresponding injector insertion hole 4.

The O-ring 8 of the first injector 10 that has been completely compressed at the second assembly step is further inserted into the injector insertion hole 4 at the third assembly step while the compressive force formed at the second assembly step is maintained.

A length by which the first injector 10 is inserted into the corresponding injector insertion hole 4 at the first assembly step is the same as a length by which the second injector 12 is inserted into the corresponding injector insertion hole 4 at the second assembly step. Insertion force applied to the first injector 10 at the first assembly step is the same as insertion force applied to the second injector 12 at the second assembly step.

Furthermore, a length by which the first injector 10 is inserted into the corresponding injector insertion hole 4 at the second assembly step is the same as a length by which the second injector 12 is inserted into the corresponding injector insertion hole 4 at the third assembly step. Insertion force applied to the first injector 10 at the second assembly step is the same as insertion force applied to the second injector 12 at the third assembly step.

Until the third assembly step from the step at which the first injector 10 and the second injector 12 are simultaneously inserted into the respective injection insertion holes 4, an upper end of the O-ring 8 mounted to the first injector 10 remains collinear with an axial center of the O-ring 8 mounted to the second injector 12. In embodiments, the back-up ring has an outer diameter smaller than an inner diameter of the insertion hole 4 to avoid interference between the back-up ring and the insertion hole 4.

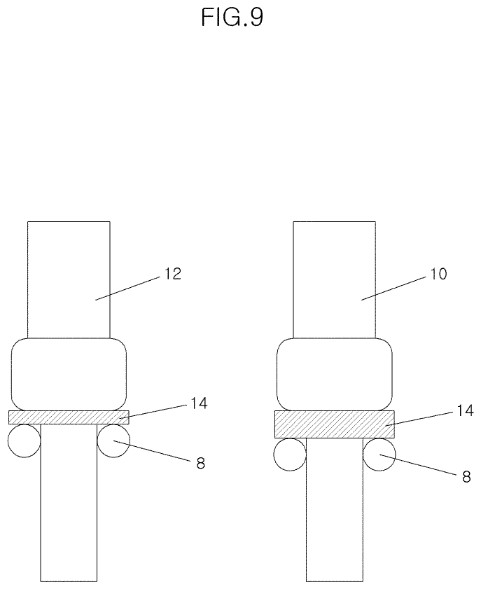

FIG. 9 illustrates an injector system of the DPI engine system in accordance with embodiments of the present invention.

A plurality of injectors including a first injector 10 and a second injector 12 are inserted into and assembled with each intake port 2.

An O-ring 8 and a back-up ring 14 are mounted to each of the first and second injectors 10 and 12 and used to fix the corresponding injector 10, 12 to the intake port 2 when the injector 10, 12 is inserted into the injector insertion hole 4.

The axial length of the back-up ring 14 mounted to the first injector 10 is different from that of the back-up ring 14 mounted to the second injector 12. In the present embodiment illustrated in FIG. 9, the axial length of the back-up ring 14 mounted to the first injector 10 is greater than that of the back-up ring 14 mounted to the second injector 12.

Each back-up ring 14 is mounted behind the corresponding O-ring 8 with respect to a direction in which the first injector 10 and the second injector 12 are inserted into the respective injector insertion holes 4.

The first injector 10 and the second injector 12 have the same size and the same shape. The injector insertion holes 4 through which the first and second injectors 10 and 12 are inserted into the intake port 2 also have the same size and the same shape.

If the axial length of the back-up ring 14 mounted to the first injector 10 is the same as that of the back-up ring 14 mounted to the second injector 12, when the first injector 10 and the second injector 12 are simultaneously inserted into the respective injector insertion holes 4, the O-rings 8 are positioned at the same position with respect to the axial direction of the first and second injectors 10 and 12. Therefore, the O-ring 8 mounted to the first injector 10 and the O-ring 8 mounted to the second injector 12 may start to be compressed at the same point in time.

However, in embodiments of the present invention, the back-up rings 14 have different axial lengths. Thus, when the first injector 10 and the second injector 12 are simultaneously inserted into the corresponding injector insertion holes 4, the O-rings 8 respectively mounted to the first and second injectors 10 and 12 start to be compressed at different points in time.

Hereinafter, a method of assembling the first injector 10 and the second injector 12 with the intake port 2 by inserting the first and second injectors 10 and 12 into the respective injector insertion holes 4 in accordance with embodiments will be described in detail.

The injector assembly method in accordance with embodiments includes: the step of simultaneously inserting the first injector 10 and the second injector 12 into the respective injector insertion holes 4; a first assembly step at which the O-ring 8 mounted to the first injector 10 starts to be compressed; a second assembly step at which the compression of the O-ring 8 mounted to the first injector 10 is completed and the O-ring 8 mounted to the second injector 12 starts to be compressed; and a third assembly step at which the compression of the O-ring 8 mounted to the second injector 12 is completed.

The first injector 10 and the second injector 12 are respectively inserted into the plurality of injector insertion holes 4 formed in the single intake port 2. Although the insertion operations of the first and second injectors 10 and 12 are simultaneously performed, the positions of the O-rings 8 respectively mounted to the first and second injectors 10 and 12 differ from each other with respect to the axial direction of the first and second injectors 10 and 12 because of the back-up rings 14 that are respectively mounted to the first and second injectors 10 and 12 and have different axial lengths.

In embodiments of the present invention, the axial length of the back-up ring 14 mounted to the second injector 10 is greater that of the back-up ring 14 mounted to the second injector 12. Hence, when the O-ring 8 mounted to the first injector 10 starts to be compressed after the first injector 10 and the second injector 12 are inserted into the respective injector insertion holes 4, the O-ring 8 mounted to the second injector 12 does not start to be compressed.

As the operations of inserting the first and second injectors 10 and 12 into the respective injector insertion holes 4 continue, the compression of the O-ring 8 mounted to the first injector 10 is completed according to the shape of the injector insertion hole 4, and then the O-ring 8 mounted to the second injector 12 starts to be compressed.

As the insertion operations of the first and second injectors 10 and 12 continue after the O-ring 8 mounted to the second injector 12 has started to be completed, the compression of the O-ring 8 mounted to the second injector 12 is completed according to the shape of the corresponding injector insertion hole 4.

The O-ring 8 of the first injector 10 that has been completely compressed at the second assembly step is further inserted into the injector insertion hole 4 at the third assembly step while the compressive force formed at the second assembly step is maintained.

A length by which the first injector 10 is inserted into the corresponding injector insertion hole 4 at the first assembly step is the same as a length by which the second injector 12 is inserted into the corresponding injector insertion hole 4 at the second assembly step. Insertion force applied to the first injector 10 at the first assembly step is the same as insertion force applied to the second injector 12 at the second assembly step.

Furthermore, a length by which the first injector 10 is inserted into the corresponding injector insertion hole 4 at the second assembly step is the same as a length by which the second injector 12 is inserted into the corresponding injector insertion hole 4 at the third assembly step. Insertion force applied to the first injector 10 at the second assembly step is the same as insertion force applied to the second injector 12 at the third assembly step.

Until the third assembly step from the step at which the first injector 10 and the second injector 12 are simultaneously inserted into the respective injection insertion holes 4, an upper end of the O-ring 8 mounted to the first injector 10 remains collinear with an axial center of the O-ring 8 mounted to the second injector 12.

As described above, due to the improved shape of the injector in accordance with embodiments of the present invention, the maximum insertion force required when the injectors 10 and 12 each provided with the O-ring 8 are inserted into the respective injector insertion holes in the DPI engine system may be reduced, whereby the injector insertion operation may be facilitated.

The injector having a structure capable of reducing required insertion force and an assembly method thereof according to embodiments of the present invention are only illustrative. A person having ordinary skill in the art to which the present invention pertains will easily understand that embodiments of the present invention may be modified in various ways and that other equivalent embodiments are possible. Therefore, it will be understood that the present invention is not limited to the embodiments described in the detailed description. Accordingly, the bounds and scope of the present invention should be determined by the technical spirit of the following claims. Furthermore, it should be understood that the present invention includes all of changes, equivalents and substitutes without departing from the bounds and scope of the present invention defined by the appended claims.

What is claimed is:

1. An injector system of an engine comprising:
a plurality of injectors mounted to a single intake port having injector insertion holes and inserted into respective injector insertion holes,
wherein the plurality of injectors comprise a first injector and a second injector,
wherein an O-ring and a back-up ring are mounted to each of the first and second injectors, and
wherein an axial length of the back-up ring mounted to the first injector is different from an axial length of the back-up ring mounted to the second injector.

2. The injector according to claim 1, wherein the O-ring has an outer diameter smaller than an inner diameter of the injector insertion hole when the O-ring is not deformed, wherein the back-up ring has an outer diameter smaller than the inner diameter of the injector insertion hole.

3. The injector according to claim 1, wherein the back-up ring is disposed at a position closer to a rear end of the corresponding injector than is the O-ring.

4. A method of making an injector system, the method comprising:
providing a first injector and a second injector which are to be mounted to a single intake port having insertion holes, and inserted into respective injector insertion holes, wherein an O-ring and a back-up ring are mounted to each of the first and second injectors, and wherein an axial length of the back-up ring mounted to the first injector is greater than an axial length of the back-up ring mounted to the second injector;
simultaneously inserting the first injector and the second injector into the respective injector insertion holes such that:
at a first assembly operation time point, the O-ring mounted to the first injector starts to be compressed,
at a second assembly operation time point, the compression of the O-ring mounted to the first injector is completed and the O-ring mounted to the second injector starts to be compressed, and
at a third assembly operation time point, the compression of the O-ring mounted to the second injector is completed.

5. The assembly method according to claim 4, wherein the O-ring mounted to the second injector is not compressed at the first assembly operation time point.

6. The assembly method according to claim 4, wherein, between the second and third assembly operation time points, the O-ring mounted to the first injector is additionally inserted into the corresponding injector insertion hole while the O-ring of the first injector maintains compressed.

7. The assembly method according to claim 4, wherein an insertion force applied to the first injector at the first assembly operation time point is substantially the same as an insertion force applied to the second injector at the second assembly operation time point.

8. The assembly method according to claim 4, wherein a length by which the first injector is inserted into the corresponding injector insertion hole at the first assembly operation time point is substantially the same as a length by which the second injector is inserted into the corresponding injector insertion hole at the second assembly operation time point.

9. The assembly method according to claim 4, wherein an insertion force applied to the first injector at the second assembly operation time point is substantially the same as an insertion force applied to the second injector at the third assembly operation time point.

10. The assembly method according to claim 4, wherein a length by which the first injector is inserted into the corresponding injector insertion hole at the second assembly operation time point is substantially the same as a length by which the second injector is inserted into the corresponding injector insertion hole at the third assembly operation time point.

11. The assembly method according to claim 4, wherein the back-up ring is disposed at a position closer to a rear end of the first injector than is the O-ring.
